(19) United States
(12) Patent Application Publication
(10) Pub. No.: US 2014/0229389 A1
(43) Pub. Date: Aug. 14, 2014

(54) INDUSTRIAL AUTOMATION SOCIAL MEDIA PARADIGMS

(71) Applicant: Rockwell Automation Technologies, Inc., Mayfield Heights, OH (US)

(72) Inventors: Michael Pantaleano, Willoughby, OH (US); David F. Mayewski, Aurora, OH (US); Daniel DeYoung, Hudson, OH (US)

(73) Assignee: Rockwell Automation Technologies, Inc., Mayfield Heights, OH (US)

(21) Appl. No.: 14/180,065

(22) Filed: Feb. 13, 2014

Related U.S. Application Data
(60) Provisional application No. 61/764,786, filed on Feb. 14, 2013.

(51) Int. Cl. G06Q 50/00; G06Q 10/10

(52) U.S. Cl. CPC G06Q 50/01; G06Q 10/103
USPC 705/300; 705/301

(57) ABSTRACT

An industrial social media platform facilitates sharing of design, maintenance, and operational information relating to a planned or installed industrial control system. The industrial social media platform shares information between personnel involved in the design and testing of the control system, including plant engineers, original equipment manufacturers, system integrators, maintenance personnel, and equipment operators. The industrial social media platform creates an industrial social media page for a new control system prior to or during the design phase. Subscribers to the industrial social media page can share relevant information during design and testing of the industrial system, including design specifications, preferred engineering standards, schedules, acceptance test results, etc. After the industrial control system is deployed, the industrial social media page can be re-configured to share data relating to operation and maintenance of the system.

### CROSS-REFERENCE TO RELATED APPLICATIONS

This application claims priority to U.S. Provisional Application Ser. No. 61/764,786, filed on Feb. 14, 2013, entitled “INDUSTRIAL AUTOMATION SOCIAL MEDIA PARADIGMS,” the entirety of which is incorporated by reference.

### TECHNICAL FIELD

This disclosure relates generally to web-based social interfaces for sharing industrial system data between plant personnel, original equipment manufacturers, system integrators, and/or machine builders.

### BACKGROUND

The cycle of designing, deploying, operating, and maintaining an industrial control and/or automation system is a collaborative endeavor involving many participants with different roles from several different business entities. For example, an industrial enterprise may contract an original equipment manufacturer (OEM) to design and install an industrial machine in a production area of industrial enterprise's facility. The design phase for this project may involve collaboration between the original equipment manufacturer (OEM) responsible for designing and building all or a portion of the machine, various plant personnel associated with the industrial entity (e.g., a plant engineer responsible for managing the project, a shift supervisor to provide recommendations regarding operational and user interface requirements, a maintenance engineer who must be trained to maintain the machine, accounting personnel, etc.), one or more system integrators who may be subcontracted by the OEM to provide design or programming services, and electrical subcontractors responsible for installation and wiring of the new machine.

Once the system is installed and operational, further collaboration is required to operate and maintain the system. For maintenance issues, this may involve interaction between plant personnel at the plant facility (e.g., maintenance personnel, a machine operator, a shift supervisor, etc.) and remote technical support personnel, who may be located anywhere in the world. Optimizing performance of the system given the goals and unique conditions of the industrial enterprise may involve interaction between plant personnel and process specialists with expert knowledge of the particular process being carried out by the new system.

All phases of the lifecycle of a given industrial machine (design, operation, maintenance, and optimization) require cooperation and coordination between these diverse and often geographically distributed participants. Because of the number of participants involved and the fact that these participants are often located across geographic boundaries, sharing of relevant information between these participants can be difficult, often requiring redundant effort to ensure that all relevant parties receive the information required to carry out their respective tasks. Moreover, one party may be required to re-generate or re-obtain information that has already been generated by another party during an earlier phase of the machine's lifecycle.

The above-described deficiencies of today's industrial control systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

One or more embodiments of the present disclosure relate to the use of an industrial social media platform that facilitates web-based sharing of design and operational information between plant personnel, original equipment manufacturers (OEMs), technical support personnel, customers, or other relevant personnel involved in design, installation, operation, and maintenance of an industrial automation system. To this end, the industrial social media platform provides an environment that allows creation of a social media site for a given project. In an example scenario, the project may relate to an agreement by an OEM to design, build and install a new industrial system or machine for an industrial entity (e.g., the OEM's customer). Once created, the project-specific social media site allows personnel associated with the OEM, the industrial enterprise, and any other relevant third-party entities to subscribe to the site to facilitate sharing of project-related information between the relevant parties. The users can then begin uploading information and documentation to the social media site. Thus, the social media site serves as a common resource for information relating to the project that is accessible to all relevant personnel. Information that can be uploaded to the project-specific social media site can include, but is not limited to, contractual agreements between the OEM and the industrial entity, design specifications, the industrial entity's design standards and approved equipment and service vendors, project milestone dates and other schedule information (e.g., factory acceptance test dates, site acceptance test dates, etc.), reports (e.g., factory and site acceptance test results), project documentation, discussion and comments, photographs, and other such information.

In one or more embodiments, each user subscribed to the project site can be assigned a personal social media page that displays posted information in an information feed. Through their personal social media page, each user can subscribe or unsubscribe to selected aspects of the project, depending on their interest or role within the larger project.

After installation of the industrial system, the social media site for the project can be linked to a new social media site for operation and maintenance of the installed system. Some or all of the information generated during the design phase can be ported to the new operation and maintenance page. This new page allows subscribers to share and view information relating to operation or maintenance concerns, thereby providing a platform to deliver notifications of maintenance issues and to remotely collaborate on possible solutions.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a high-level representation of an industrial social media platform.

FIG. 2 is a block diagram of an industrial social media system.

FIG. 3 illustrates an industrial social media system that facilitates sharing of project information between an OEM and a customer in a design and installation scenario.

FIG. 4 illustrates distribution of project updates to diverse subscribers using an industrial social media platform.

FIG. 5 illustrates a system that facilitates sharing of maintenance information using an industrial social media platform.

FIG. 6 illustrates a system that facilitates automated technical support via an industrial social media platform.

FIG. 7 illustrates a system that facilitates delivery of operational data from selected devices, machines, or production lines to subscribers using an industrial social media platform.

FIG. 8 illustrates an exemplary industrial social media page.

FIG. 9 is a flowchart of an example methodology for sharing project design and installation data via an industrial social media platform.

FIG. 10 is a flowchart of an example methodology for sharing maintenance information via an industrial social media platform.

FIG. 11 is a flowchart of an example methodology for receiving operation updates from an automation system via an industrial social media page.

FIG. 12 is an example computing environment.

FIG. 13 is an example networking environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

The industrial social media platform described herein can facilitate web-based sharing of design, operation, and maintenance information between plant personnel, original equipment manufacturers (OEMs), or other relevant personnel involved in design, installation, operation, and maintenance of an industrial automation system. While certain examples set forth in this disclosure will be particular to information sharing between plant personnel and an OEM, it is to be appreciated that the systems and methods described herein can facilitate information sharing with other types of participants as well (e.g., system integrators, machine builders, solution providers, etc.).

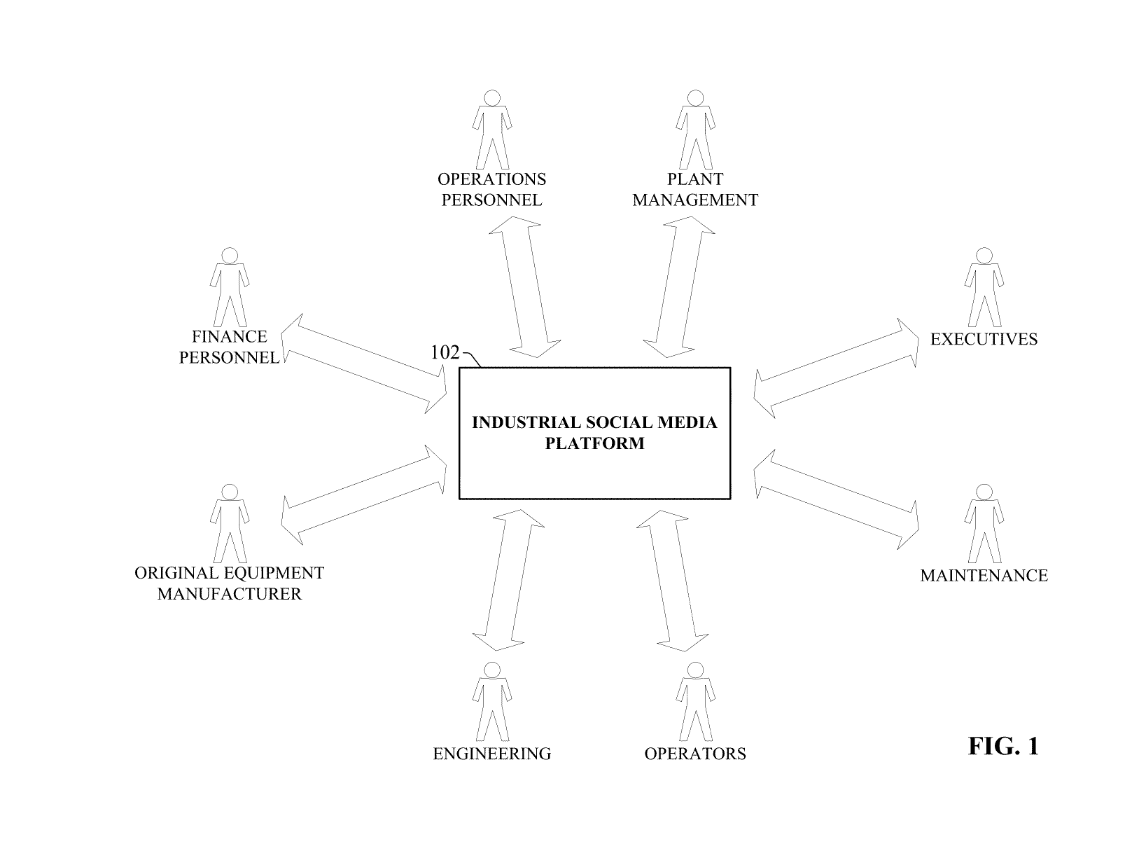

FIG. 1 illustrates a high-level representation of an industrial social media platform that can be used to share industrial project, installation, operation, and/or maintenance information between subscribers or participants. The industrial social media platform 102 can reside and execute on a web-based platform (e.g., one or more web servers) or a cloud platform, and can provide an intuitive customizable interface that facilitates sharing of project or machine data between OEMs, plant engineering personnel, line operators, maintenance personnel, operations personnel, plant management, finance personal, plant executives, third-party service providers, drives or instrument suppliers, or other relevant participants. Users can create a project in the industrial social media platform 102 relating to a particular installation project or existing automation system. Participants can also create their own personal social media pages, which can be customized to render updates relating to selected aspects of the project throughout the project's lifecycle. Through their personal social media pages, participants can subscribe to selected aspects of the project for which they wish to receive updates. As will be described in more detail below, industrial social media platform 102 can be used to facilitate sharing of information between participants across many stages of a project's lifecycle, including design, operation, maintenance, and optimization.

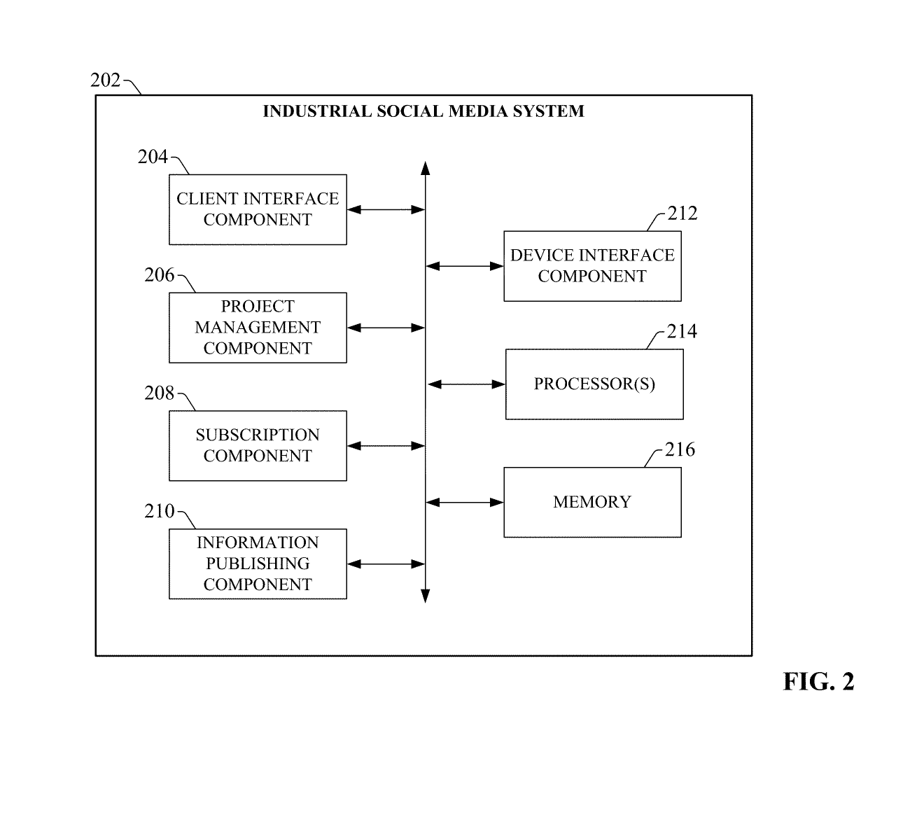

FIG. 2 is a block diagram of an industrial social media system that can facilitate web-based sharing of design, operation, and maintenance information. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Industrial social media system 202 can include a client interface component 204, a project management component 206, a subscription component 208, a publishing component 210, a device interface component 212, one or more processors 214, and memory 216. In various embodiments, one or more of the client interface component 204, the project management component 206, the subscription component 208, the publishing component 210, the device interface component 212, one or more processors 214, and memory 216 can be electrically and/or communicatively coupled to one another to perform one or more of the functions of the industrial social media system 202. In some embodiments, components 204, 206, 208, 210, and 212 can comprise software instructions stored on memory 216 and executed by processor(s) 214. Industrial social media system 202 may also interact with other hardware and/or software components not depicted in FIG. 2. For example, processor(s) 214 may interact with one or more external user interface devices, such as a keyboard, a mouse, a display monitor, a touchscreen, or other such interface devices.

Client interface component 204 can be configured to exchange data with one or more client devices via a network connection, such as an Internet connection. This can include, for example, receipt of data requesting creation and configuration of a project social media page, receipt of requests from client devices to subscribe a user to a selected project page, receipt of project-related information to be published on a project's social media page (e.g., project documentation, comments and discussions, project schedules, etc.), delivery of social media pages and associated data to requesting client devices, and other such information.

Project management component 206 can be configured to create and maintain social media pages associated with respective different projects based on user input. Subscription component 208 can be configured to manage user profiles created and configured based on user input. This can include maintaining records of all users subscribed to a project (including the user's name and role, the business entity to which the user belongs, and other relevant information), managing associations between each user and one or more projects to which the user is subscribed (including individual aspects of each project to which the user is subscribed), and other such user profile data.

Publishing component 210 can be configured to process data relating to a particular project and publish the data to the appropriate social media page for the project. Such project data may be sent to the industrial social media system 202 by authorized users who are subscribed to the project. Device interface component 212 can be configured to receive industrial device data sent by one or more internet-capable or cloud-capable industrial devices (e.g., industrial controllers, drives, telemetry devices, etc.), cloud gateways, or other sources of device data. In some embodiments, the information publishing component can publish this device data to the appropriate project-specific social media page so that the data can be viewed by subscribing users. The one or more processors 214 can perform one or more of the functions described herein with reference to the systems and/or methods disclosed. Memory 216 can be a computer-readable storage medium storing computer-executable instructions and/or information for performing the functions described herein with reference to the systems and/or methods disclosed.

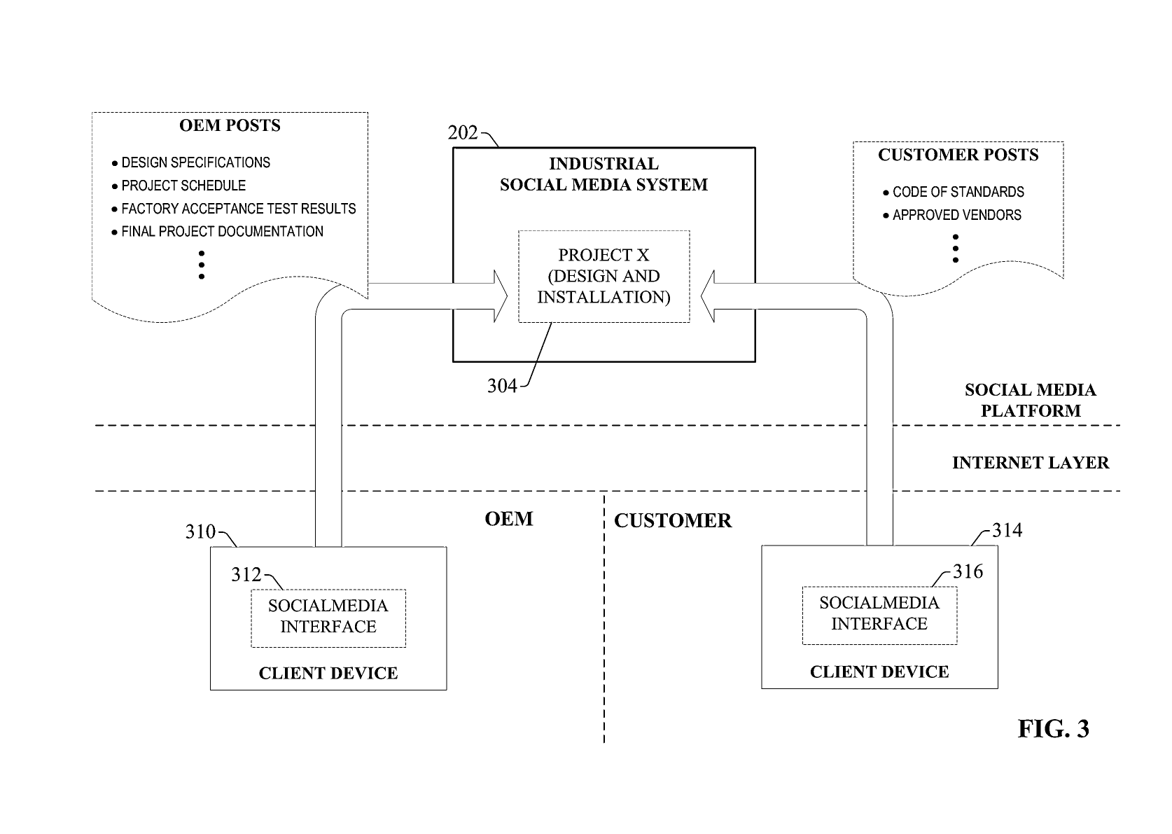

FIG. 3 illustrates use of the industrial social media platform to facilitate sharing of project information between an OEM and a customer (e.g., an industrial enterprise that purchases a custom machine from the OEM) in a design and installation scenario. Industrial social media system 202 resides on a web-based or cloud-based platform accessible via an Internet layer. Users associated with the OEM or customer site can interact with the industrial social media system 202 via any suitable web-capable client device, such as OEM client device 310 or customer client device 314. Client devices 310 and 314 can include, but are not limited to, desktop computers, laptop computers, or web-capable mobile devices such as mobile phones or tablet computers. To facilitate receiving data from and presenting data to the user, industrial social media system 202 can serve social media interfaces 312 and 316 to the respective client devices 310 and 314, which serve as user interfaces to the social media environment.

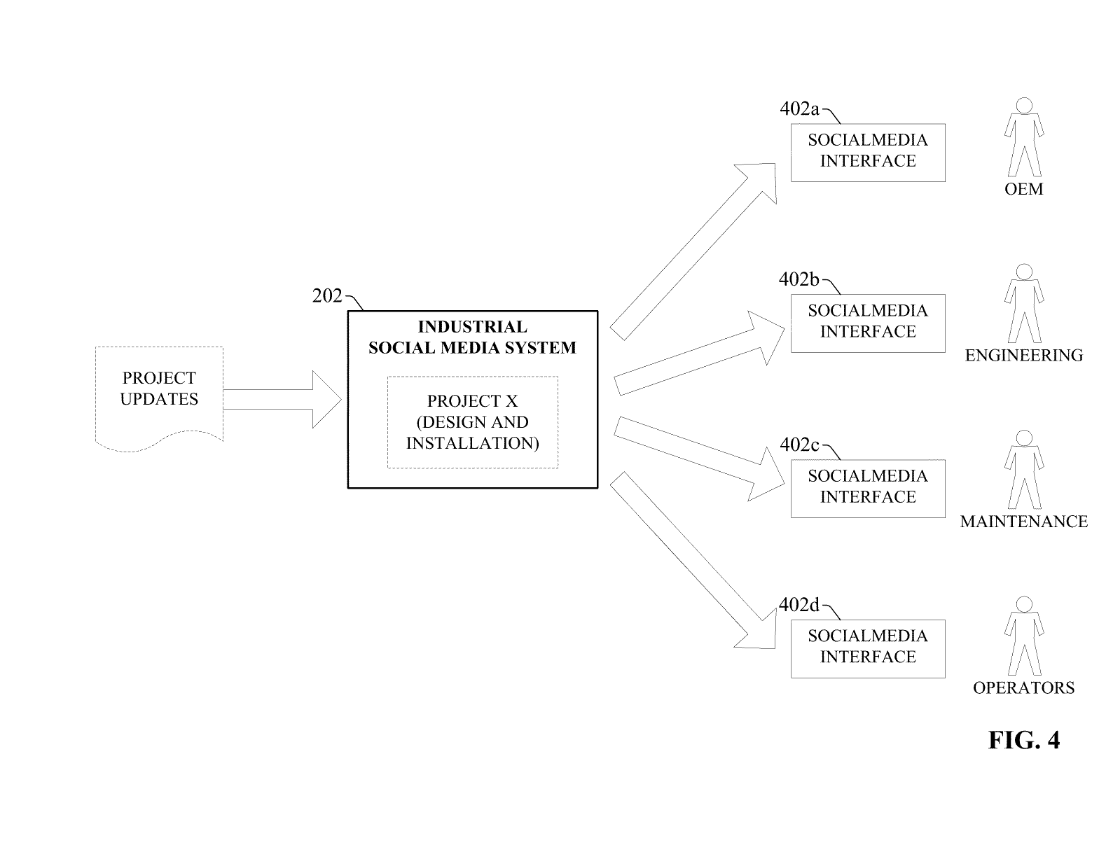

In this example, the OEM has been contracted by the customer to build a new machine to manufacture a new product, which will be installed on an existing line at one of the customer's plant facilities. A member of the OEM's engineering team in charge of the project can create a new project 304 on the industrial social media system 202 (called “Project X”). Creation of new project 304 involves creating a new social media site for Project X and granting access rights to the appropriate OEM and customer personnel. As illustrated in FIG. 4, all authorized personnel, including but not limited to OEMs, engineering personnel, maintenance personnel, machine operators, and system integrators, can be provided with a personal social media page accessible via a social media interface 402 delivered by the industrial social media system 202 to each user's personal device. Each user can subscribe to receive updates relating to the project via their personal social media pages. Subsequently, when updates relating to the project are posted to the industrial social media system 202, the updates will be visible in each subscriber's personal social media page.

Returning now to FIG. 3, after the social media site for the new project 304 has been created, authorized personnel at the OEM and customer site can begin posting project-related materials and updates. For example, once the specifications for the new machine or system have been agreed upon, the OEM can post the specifications to the industrial social media system 202 under project 304. The industrial social media system 202 will then publish the machine or system specifications to the social media site dedicated to the project to be viewed by authorized personnel at the OEM or customer facility via their personal social media pages. In an exemplary embodiment, the specifications can be represented as an icon located at a dedicated “Specifications” area of each subscriber's personal social media page, and selecting the icon will display the specification information in more detail. Additionally, the industrial social media system 202 can allow authorized users to post comments in association with the specifications. These comments may appear in a comment thread under the specifications, thereby providing a platform for discussion between team members regarding the specifications.

A user at the customer facility may also post the uniform code of standards in use at the facility, which may convey to the OEM how some aspects of the design specification should be implemented. For example, the customer may post their automation standards, wiring standards (e.g., colors, gauges, wire numbering and labeling standards, etc.), design standards, list of preferred device or software vendors, or other in-house standards. Authorized OEM personnel who are subscribed to the project can view these posted standards via their respective personal social media pages to ensure that the customer's uniform code of standards are being adhered to during design and fabrication.

The OEM can also post a project schedule to the industrial social media system 202 for viewing by all authorized project personnel. The schedule can be updated as needed so that project management at the customer site can oversee development via their social media page. The system allows authorized users to add comments to the schedule (or to particular milestone events listed on the schedule), providing a platform for users to discuss particular project events. For example, the project schedule may include an entry for the scheduled factory acceptance test (FAT), during which personnel from the customer facility will visit the OEM facility to verify proper operation of the machine or system (e.g., I/O testing, functional testing, visual inspection, etc.). If a key member of the customer's engineering team is unavailable on the scheduled date, that member can post a comment on the appropriate schedule item requesting that the FAT be rescheduled to another date. In one or more embodiments, the industrial social media system 202 can present the project schedule on the users' personal social media pages as an animated timeline or project history, such that milestone items are highlighted on the schedule when an authorized user confirms completion of the milestone.

Other project materials or deliverables can be posted to the industrial social media platform as the project progresses. For example, upon completion of the FAT, customer acceptance documentation can be posted to the industrial social media system 202 for access and viewing by other users via their personal social media pages. This documentation can include a list of functional requirements that were confirmed as being satisfied during the test, identification of requirements that were not satisfied and are therefore pending confirmation, one or more electronic signatures of plant personnel confirming acceptance that one or more functional requirements were demonstrated to be satisfied, or other such FAT documentation. When the project is completed, the OEM can post other project deliverables to the industrial social media system 202 (e.g., finalized drawings, manuals, etc.), which can then be viewed or downloaded by authorized users at the customer site.

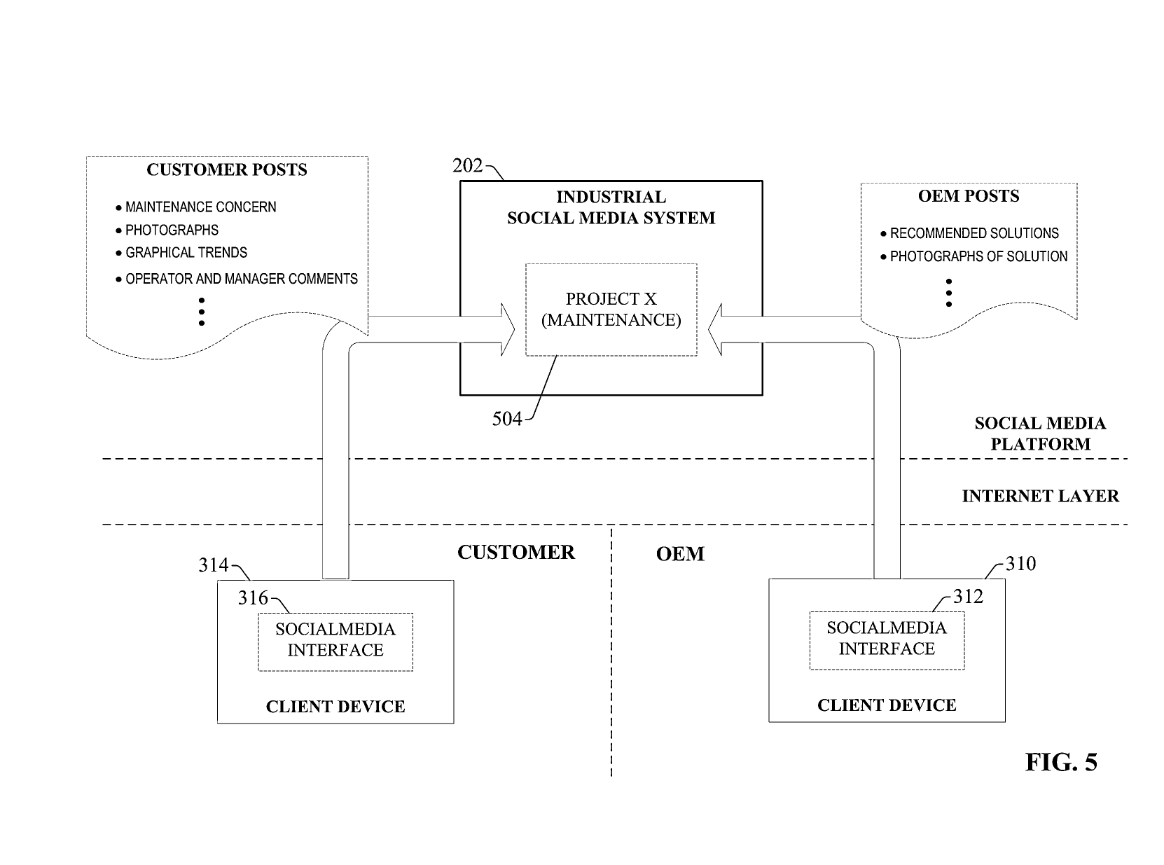

When Project X is completed and delivered, the social media pages associated with the project can be archived and linked to a new social media site dedicated to operation and maintenance of the new system. Converting the social media pages for the new system from project mode to operation/maintenance mode can unlock a different set of interface features tailored to operation and maintenance of the new system. FIG. 5 illustrates use of the industrial social media platform to facilitate sharing of maintenance information. In this example, Project X has been linked to a new social media page 504 having features that facilitate sharing of information relating to maintenance of the installed system. Some or all of the project history data generated during the design and implementation stage can be imported into social media page 504 from project 304 (see FIG. 3).

Personnel at the customer facility (e.g., maintenance managers, operations managers, operators, etc.) can subscribe to the Project X social media page 504. Project managers at the OEM who were involved in the design and implementation of the new machine or system can also subscribe to the social media page 504 for Project X. In an example scenario, a line operator may notice an issue on the new machine or system that warrants investigation by maintenance personnel. For example, upon reviewing a data trend on a human-machine interface (HMI) screen associated with the line, the operator may notice that a heat spike occurs approximately every nine hours. Accordingly, the operator can post a message on the project's social media page 504 reporting the issue. In some embodiments, the operator can access the social media page 504 via a personal or shared client device 314 (e.g., a smart phone, a desktop computer, a laptop computer, etc.).

In other embodiments, the HMI itself can be configured to access the social media page 504 to simplify the process of posting operational issues to the social media platform. In an example of such an embodiment, the operator can select an option on the HMI's trend screen that invokes a “send to social media” function (e.g., via a right-click menu or a dedicated social media button on the HMI screen). In response to selection of this function, the HMI can present the operator with an option to select which social media project the trend should be posted to. This may also include identifying a particular sub-category within the project, such as a particular work area or production line to which the trend relates (e.g., Production Line 1). Based on the operator's selection, the HMI can then post a copy of the trend to the selected social media project page. The HMI can also allow the operator to add comments or additional graphics to the post elaborating on the heat spike concern. For example, the operator can add a comment noting that the heat spike occurs approximately every nine hours, and add a highlight to the copy of the trend indicating the heat spike. All information posted by the operator (either using the HMI controls as described above or using the operator's personal device) is then published by the HMI to the industrial social media system 202 in association with the relevant project and/or production area (e.g., Production Line 1), and can be viewed by other authorized personnel who are subscribed to that project through their respective personal social media pages.

After the operator has posted the trend and associated comments, a plant manager in charge of the line may log onto his or her personal social media page to review recent postings. Since the plant manager has previously subscribed to receive postings relating Project X, including postings relating particularly to Production Line 1 (which may be a sub-category of Project X), the operator's posting will appear on the plant manager's personal social media page. The manager can then add his or her own comments to the operator's post offering suggestions or observations. For example, the manager may add a comment noting that the temperature spike is high but not critical, and ordering that maintenance personnel should schedule a time to review the issue that week. The manager can also flag the post as an issue to be discussed during the next shift meeting. All posts and flags pertaining to Production Line 1 entered by the plant manager via his or her personal social media page are published to the industrial social media system 202, and thereby made visible to other Project X subscribers via their respective personal social media pages.

A maintenance team leader, who is also subscribed to receive updates relating to Line 1, may see the operator's original post regarding the temperature spike as well as the manager's comments under the posting. The industrial social media system 202 makes this information visible on the information feed of the maintenance team leader's personal social media page. In response, the maintenance team leader may dispatch maintenance personnel to investigate the issue.

Meanwhile, the OEM's project engineer—who designed and installed the affected machine on Production Line 1—may also be subscribed to receive updates relating to the Production Line 1 category of the Project X social media page. The OEM may choose to contribute to the dialog if he or she has a relevant observation about the problem. For example, the OEM may have seen a similar heat spike issue on another customer's installation. Accordingly, the OEM may post comments under the original posting offering suggestions regarding how to solve the problem. In addition to text comments, the OEM's posting can include photographs or other graphical files that may assist the customer with solving the problem. For example, if the OEM recognizes that an improperly sealed thermocouple sometimes causes the temperature spikes seen in the trend, the OEM can take a photograph of a properly sealed thermocouple on a similar machine and post the photograph under the operator's original posting together with an explanation that improperly sealed thermocouples may cause overheat approximately every nine hours. Upon receipt of this information, the industrial social media system 202 publishes the photograph and the OEM's comments to the social media feed of each subscriber.

Maintenance personnel at the customer site, seeing the OEM's posting in their social media feed, may then act on the OEM's advice. Once the thermocouple has been fixed and the operators confirm that the temperature spike has been mitigated, the maintenance personnel or the plant manager may post a comment under the original posting confirming that the issue has been resolved. Additionally, maintenance personnel may configure an HMI alarm to monitor the heat trend over the next 10 hours to confirm that the problem does not reoccur.

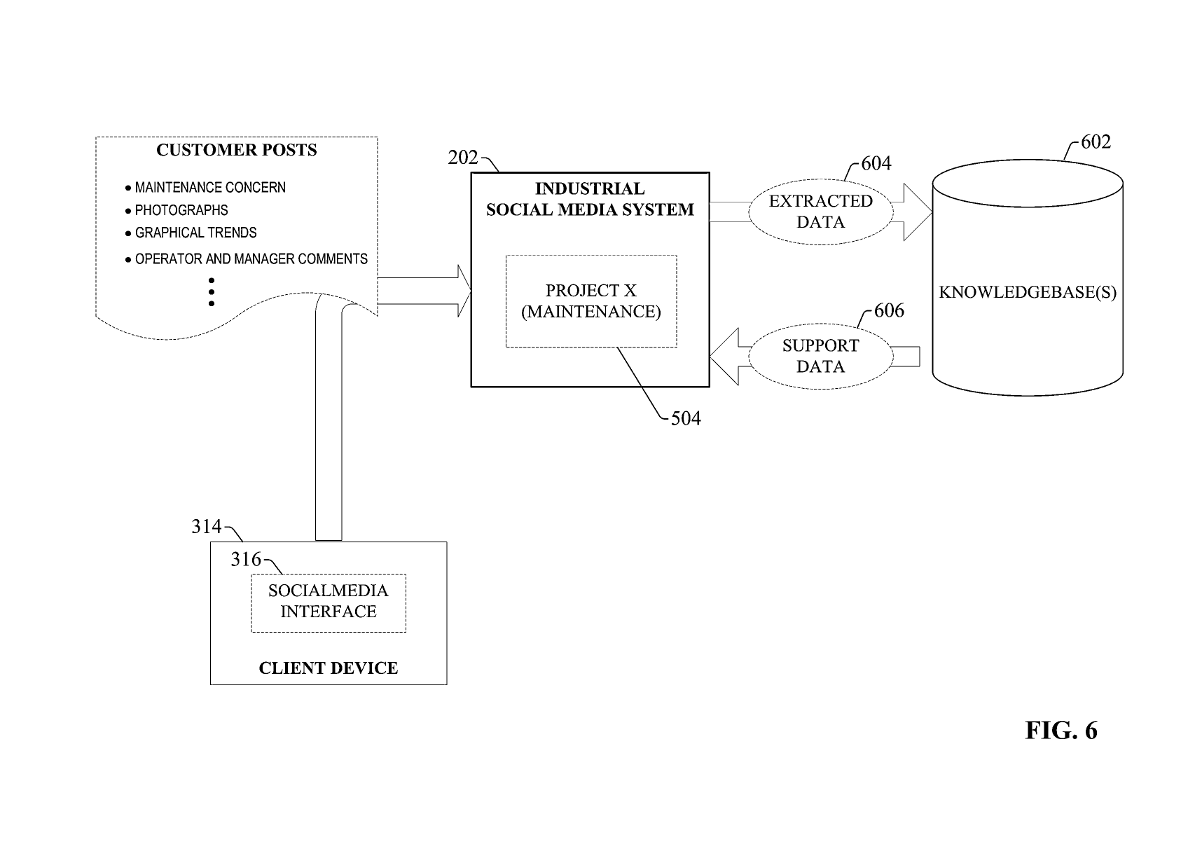

In addition to providing a platform for dialog between relevant personnel as described above, some embodiments of the industrial social media system may also be configured to extract relevant information from the operator's original post to the social media page reporting the heat spike issue, and submit the extracted information to a remote knowledgebase or multiple distributed knowledge sources to facilitate immediate automated assistance via the social media platform. As illustrated in FIG. 6, such embodiments of the industrial social media system can analyze a post relating to an operational or maintenance concern, and extract such information as device identifiers (e.g., model numbers, vendor information, etc.), keywords indicative of the operational or maintenance issue, operational statistics (e.g., measured trend information posted by the user, where the trend information may correspond to performance or process measurements such as speed, temperature, pressure, flow, etc.), image data extracted from a photograph submitted by the user, or other relevant data that may be pertinent to diagnosis of the issue and determination of a countermeasure.

The industrial social media system 202 can then submit the extracted data 604 to one or more web-based or cloud-based knowledgebases 602 to facilitate generation or retrieval of technical support data 606 that may be useful in diagnosing or solving the issue. Such knowledgebases 602 can include, for example, one or more product resource knowledgebases containing information relating to specific industrial devices or other vendor products. Product data stored in product resource knowledgebase may be administered by one or more product vendors or OEMs. Exemplary device-specific data maintained by such product resource knowledgebases can include product serial numbers, most recent firmware revisions, preferred device configuration settings and/or software for a given type of industrial application, or other such vendor-provided information.

Other knowledgebases may include one or more collaborative analysis knowledgebases, which may perform collective big data analysis (e.g., on a cloud platform). Such collaborative analysis knowledgebases may collect data from devices and assets comprising respective different industrial systems for storage in the web-based or cloud-based collaborative analysis knowledgebase. In some embodiments, data maintained in the collaborative analysis knowledgebase can be collected anonymously with the consent of the respective customers. For example, customers may enter into a service agreement with a technical support entity whereby the customer agrees to have their device and asset data collected by the web-based or cloud-based collaborative analysis knowledgebase in exchange for automated technical support services. The collaborative analysis knowledgebase can organize the collected data according to device type, system type, application type, applicable industry, or other relevant categories. The knowledgebase can then analyze the resulting multi-industry, multi-customer data store to learn industry-specific, device-specific, and/or application-specific trends, patterns, thresholds, etc. In general, the collaborative analysis knowledgebase can perform big data analysis on the multi-enterprise data to learn and characterize operational trends or patterns as a function of industry type, application type, equipment in use, asset configurations, device configuration settings, or other such variables. Based on this collected data, the collaborative analysis knowledgebase may, for example, determine the operational behavior of various industrial assets over time for each of different sets of operating constraints or parameters (e.g. different ranges of operating temperatures or pressures, different recipe ingredients or ingredient types, etc.). By leveraging a large amount of historical data gathered from many different industrial systems, the collaborative analysis knowledgebase can learn common operating characteristics of many diverse configurations of industrial assets at a high degree of granularity and under many different operating contexts.

Additionally, the industrial social media system 202 may also leverage extrinsic data collected from sources external to the customer's industrial enterprise, but which may have relevance to operation of the customer's industrial systems. Example extrinsic data can include, for example, energy cost data, material cost and availability data, transportation schedule information from companies that provide product transportation services for the customer, market indicator data, web site traffic statistics, information relating to known information security breaches or threats, or other such information. A web-based or cloud-based extrinsic data knowledgebase can retrieve such extrinsic data from substantially any data source; e.g., servers or other data storage devices linked to the Internet, cloud-based storage that maintains extrinsic data of interest, or other sources.

Embodiments of the industrial social media system that support the automated technical support services illustrated in FIG. 6 can submit the extracted data 604 to one or more of these knowledgebases 602, which can retrieve or generate technical support data 606 that may assist the user in diagnosing or solving the issue being reported, based on analysis of the extracted data 604 with the knowledgebase information. The industrial social media system 202 can then deliver the technical support information to relevant subscribers. The platform can deliver the technical support information using any suitable technique; e.g., by posting an automated technical support response as a sub-posting below the user's original post reporting the issue, by delivering the technical support information directly to a personal device associated with the relevant subscribers, etc. The automated technical support information can comprise, for example, a recommended parameter setting or process variable adjustment, a recommendation to replace one or more devices, contact information for a local service provider who may have experience in addressing the reported issue, identification of one or more possible causes of the issue (e.g., a possible upstream condition that may be affecting the device or system in question), or other such support information.

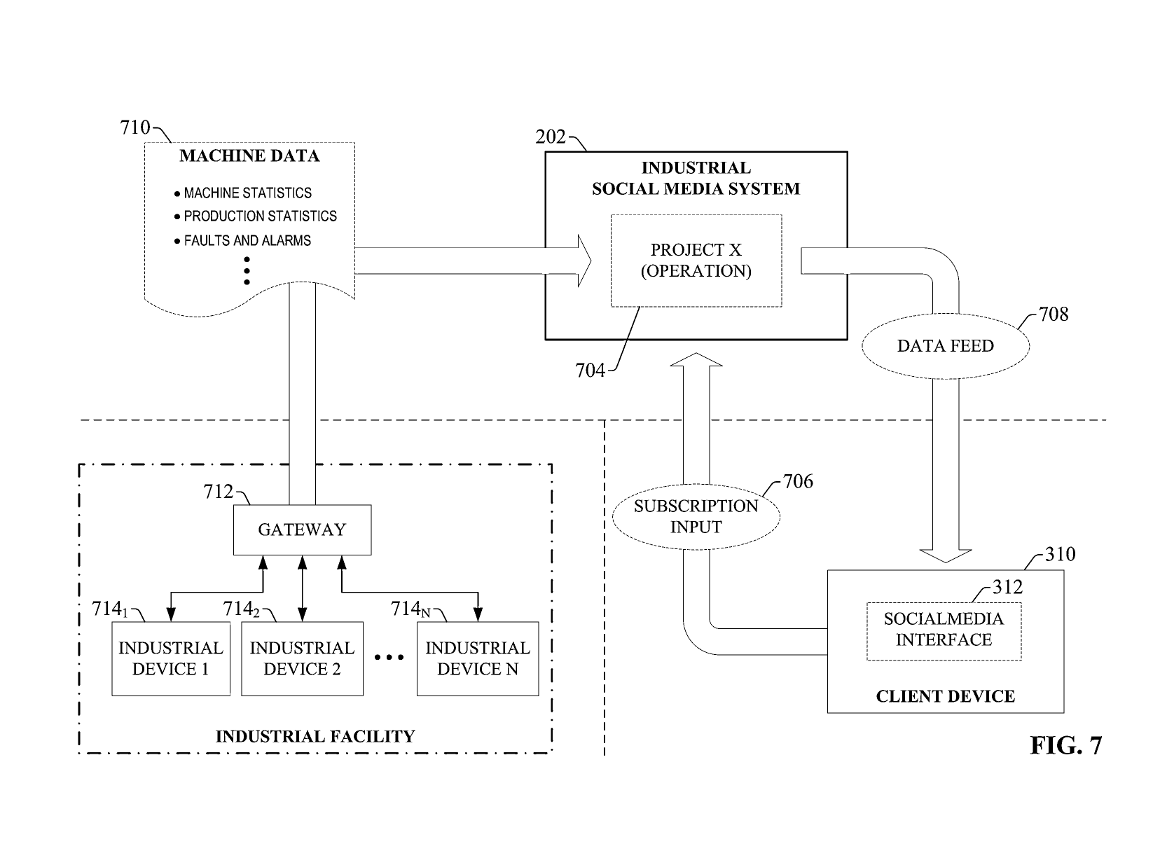

As described in the previous examples, the industrial social media platform can be used to facilitate web-based or cloud-based dialog in connection with project design, installation, and maintenance. The platform can also be used to deliver selected operational data collected from running systems to relevant authorized personnel via their industrial social media pages. FIG. 7 illustrates an embodiment of the industrial social media system 202 that delivers operational data from specific devices, machines, or production lines to subscribers. In this example, an industrial facility comprises a number of industrial devices 714₁-714_{N}. The industrial devices 714₁-714_{N} can make up one or more automation systems operating within the industrial facility. Exemplary automation systems can include, but are not limited to, batch control systems (e.g., mixing systems), continuous control systems (e.g., PID control systems), or discrete control systems. Industrial devices 714₁-714_{N} can include such devices as industrial controllers (e.g., programmable logic controllers or other types of programmable automation controllers); field devices such as sensors and meters; motor drives; human-machine interfaces (HMIs); industrial robots, barcode markers and readers; vision system devices (e.g., vision cameras); smart welders; or other such industrial devices.

Example automation systems can include one or more industrial controllers that facilitate monitoring and control of their respective processes. The controllers exchange data with the field devices using native hardwired I/O or via a plant network such as Ethernet/IP, Data Highway Plus, ControlNet, Devicenet, or the like. A given controller typically receives any combination of digital or analog signals from the field devices indicating a current state of the devices and their associated processes (e.g., temperature, position, part presence or absence, fluid level, etc.), and executes a user-defined control program that performs automated decision-making for the controlled processes based on the received signals. The controller then outputs appropriate digital and/or analog control signaling to the field devices in accordance with the decisions made by the control program. These outputs can include device actuation signals, temperature or position control signals, operational commands to a machining or material handling robot, mixer control signals, motion control signals, and the like. The control program can comprise any suitable type of code used to process input signals read into the controller and to control output signals generated by the controller, including but not limited to ladder logic, sequential function charts, function block diagrams, structured text, or other such platforms.

Although the exemplary overview illustrated in FIG. 7 depicts the industrial devices 714₁-714_{N} as residing in a fixed-location industrial facility, the industrial devices may also be part of a mobile control and/or monitoring application, such as a system contained in a truck or other service vehicle.

By interacting with the industrial social media project 704 via social media interface 312, a user can subscribe to one or more of the industrial devices 714₁-714_{N}. For example, the user can browse to the Project X social media page via client device 310 and submit subscription input 706 selecting one or more of the industrial devices 714₁-714_{N}. Subscribing to an industrial device will cause industrial social media system 202 to post operational updates relating to the selected devices on the social media feed of the user's personal social media page. In some embodiments, industrial social media system 202 can allow the user to subscribe to an entire line or production area, or to subscribe to individual machines or devices comprising the line. Subscription to a line or production area configures industrial social media system 202 to publish device-level information relating to all devices within the selected line or area to the user's social media feed. In some embodiments, subscription to a line or production area can also configure industrial social media system 202 to publish higher-level production or status information relating to the selected line or production area to the user's feed. This higher-level information can include, for example, line cycle times, daily or shift-specific product output statistics, product quality information, network communication statistics for the line or production area, purchase order information for a product produced by the line or production area, or other such area-level or line-level information. In some embodiments, industrial social media system 202 can be configured to computer some or all of this higher-level data (e.g., cycle times, production statistics, etc.) based on data received from the relevant industrial devices. Alternatively or in addition, some or all of the higher-level data can be posted to the industrial social media system 202 by one or more application running on the plant floor (e.g., production tracking applications, accounting applications, order tracking applications, etc.).

During operation, the industrial devices 714₁-714_{N} can submit machine data 710 to the industrial social media system 202. The devices 714₁-714_{N} can be coupled to the Internet or to a cloud platform by any suitable means so that data generated by the devices can be pushed to the industrial social media system 202. In an example configuration, industrial devices 714₁-714_{N} may access the industrial social media system 202 through a gateway device 712 at the industrial facility, where the industrial devices 714₁-714_{N} connect to the gateway device 712 through a physical or wireless local area network or radio link. The gateway device 712 can be a network infrastructure device that serves as a bridge between the industrial devices 714₁-714_{N} and the Internet or cloud platform. In another example configuration, the industrial devices 714₁-714_{N} may access the industrial social media system 202 directly using integrated gateway services embedded in the devices.

Data generated by the industrial devices 714₁-714_{N} and pushed to industrial social media system 202 can include, but is not limited to, machine statistics, statuses (e.g., running, idle, emergency stop, etc.), production statistics (e.g., shift product counts, cycle times, etc.), fault and alarm data, or other such data. Industrial devices 714₁-714_{N} can be configured to send machine data 610 to industrial social media system 202 periodically or in response to particular triggers (e.g., a change in status, a monitored value exceeding a setpoint, a shift change, etc.).

In some embodiments, gateway device 712 can be configured to package the data collected from industrial devices 714 for processing by industrial social media system 202. This can include, for example, appending a header to data packets containing the data identifying the social media project to which the data belongs (e.g., Project X), the device from which the data was collected, the relevant line or production area, a customer identifier, or other such information.

Upon receipt of new machine data, the industrial social media system 202 can determine the relevant project, plant, machine, and/or production area to which the data relates, as well as which users associated with the project have subscribed to receive the data in their respective social media data feeds 708. For example, if new end-of-batch data has been received from an industrial controller that controls a batch process, the industrial social media system 202 can identify which users have subscribed to the batch process, and post the end-of-batch data to those users' personal social media pages. In another example, a variable frequency drive (VFD) on a particular production line (e.g., Line 1) may switch to an abnormal state and, in response, publish an alarm status to the industrial social media system 202 (e.g., via gateway device 712). The industrial social media system 202 will post this abnormal status to the personal pages of those users who have subscribed to receive updates relating to the VFD, the production line (Line 1), or the motor on the line being controlled by the VFD.

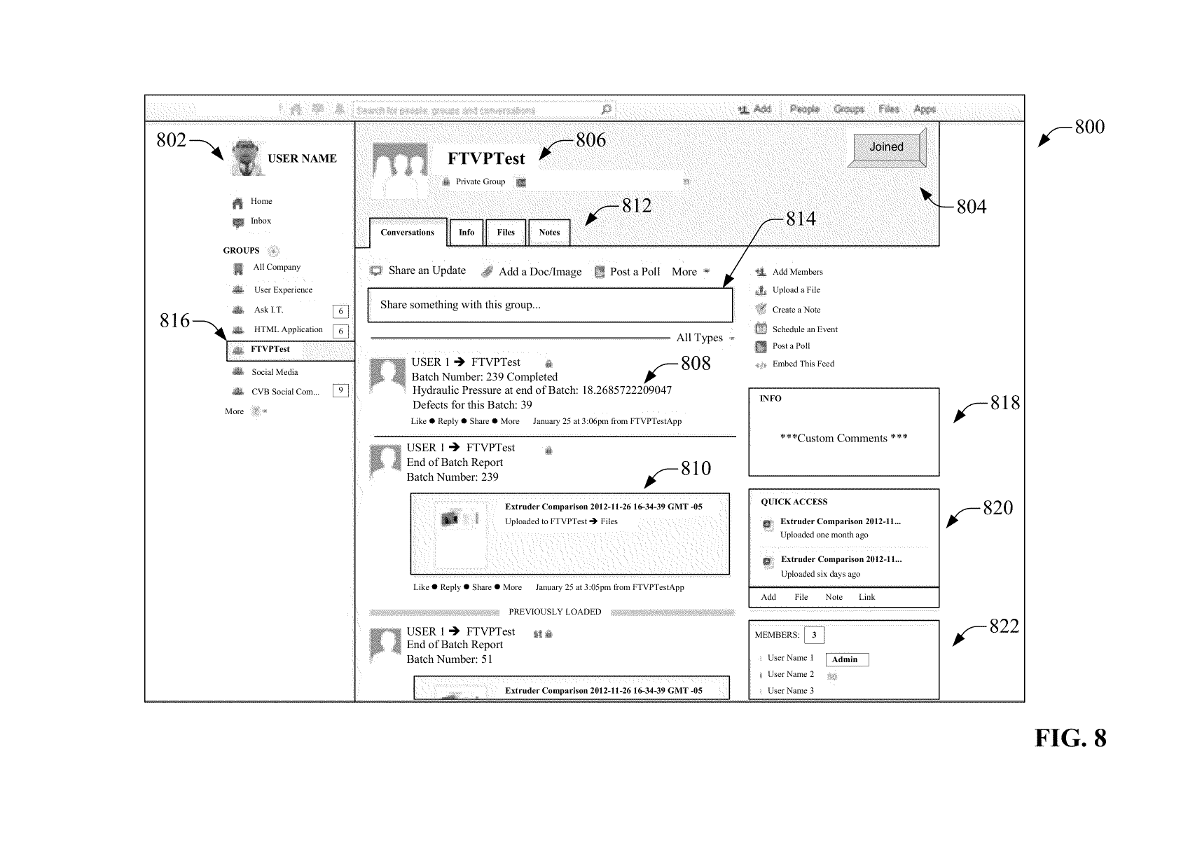

FIG. 8 illustrates an example industrial social media page 800, which can be generated by industrial social media system 202 and delivered to a subscribing user via the user's personal device (e.g., desktop computer, laptop computer, tablet computer, smart phone, etc.). In this example, the owner of the page is identified by user name 802. A group FTVPTest is identified by group name 806. The user has joined the group by selecting the Join button 804. Since the user has subscribed to the FTVPTest group, the data feed area 808 displays a timeline of posts containing end-of-batch data for a batch process associated with the FTVPTest group. Some posts may also comprise extruder comparison reports 810, which comprise files that were uploaded to industrial social media system 202 and published to the data feed. Reports 810 can be selected and viewed by the user via industrial social media page 800. The data and reports may have been uploaded to the industrial social media page 800 by another user (e.g., a shift supervisor), which then published the data and reports to the information feeds of relevant subscribing users. In other scenarios, the end-of-batch data may have been published to the industrial social media system 202 automatically by one or more industrial devices (e.g., devices 714) or by a gateway device (e.g., gateway device 712) that aggregates and summarizes batch data from the industrial devices that carry out the batch process. A comment window 814 allows a user to post a new comment to the project information feed, which is made viewable to all subscribers in the group by the industrial social media system 202.

Industrial social media page 800 can organize data categories using tabs 812. In the illustrated example, the data categories include Conversations, Info, Files, and Notes. It is to be appreciated, however, that embodiments of the social media system can organize data according to other categories without departing from the scope of this disclosure. Selecting the Conversations category can display information feeds comprising information or reports posted to the FTVPTest group, or to individual users within the group. The Conversations feed can include comments attached to individual posts by various users within the group. The Info category can comprise general information about the group, including but not limited to information about the machine, production area, or devices associated with the group, a list users subscribed to the group, etc. The Files category can include a list of files posted to the group (e.g., reports, purchase orders, photographs, etc.). In some embodiments, users can select, view, and download files that have been posted to the group by selecting the Files tab and selecting the desired file. The Notes category can include notes entered by the user associated with the page for later viewing. Each user's view of the group page can include a personalized Notes tab that allows the user to enter and save notes or reminders relating to the project, which are maintained on the industrial social media system 202 and made available for viewing whenever the user is logged onto the group page.

Since a given user may subscribe to multiple groups, a group tree 816 is provided on the left-hand side of the page. Group tree 816 lists the groups to which the user is subscribed. Selection of a group from the tree displays the information feed (and, optionally, the relevant data category tabs) for the selected group.

One or more embodiments of industrial social media page 800 can also include other data areas. For example, industrial social media page 800 may include an information box 818 on the right-hand side of the information feed that allows the user to enter custom comments for personal use (e.g., comments not to be shared with other members of the group). A quick access box 820 can include links to files (e.g., reports, photographs, etc.) that were published to the group's information feed, allowing the user to quickly locate such files without scrolling through the information feed to locate the file. A members box 822 can list the members currently subscribed to the group. Members box 822 may also identify a role of each user (e.g., administrator, project manager, engineer, operator, OEM, etc.)

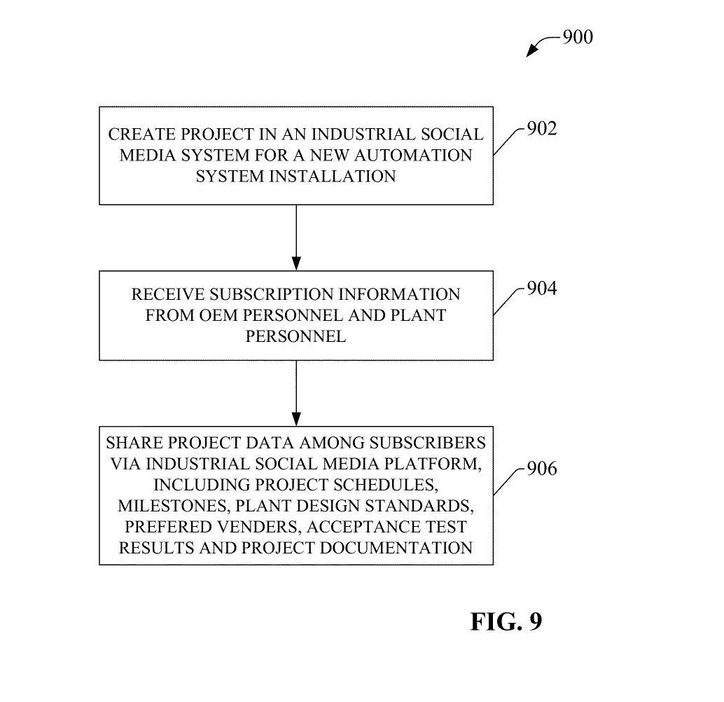

FIGS. 9-11 illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 9 illustrates an example methodology 900 for sharing project design and installation data via an industrial social media platform. Initially, at 902, a project is created in an industrial social media system. The project relates to a new industrial control and/or automation system that is to be designed and installed at a customer facility, and will be used to share project updates and documentation between participants. At 904, subscription information is received from the participants involved with the installation project. This can include plant personnel at the customer facility as well as OEM team members who will be designing and installing the automation system for the customer. At 906, project data is shared between the subscribers via the industrial social media platform. For example, the OEM team members may post such information as project schedules, project milestones, factory acceptance test results, site acceptance test results, and project documentation, while the plant personnel may post information regarding plant design standards, preferred vendors, electronic signatures indicating acceptance of test results, purchase order information, etc.

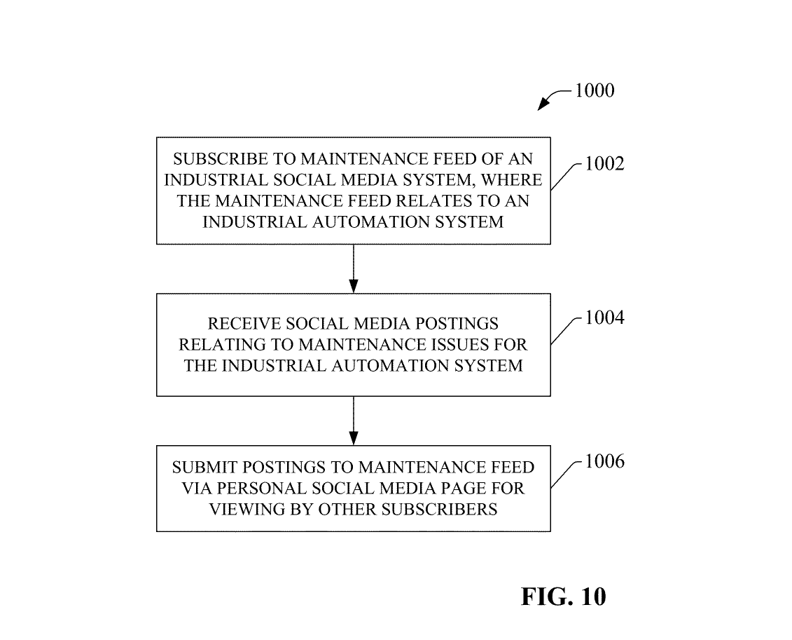

FIG. 10 illustrates an example methodology 1000 for sharing maintenance information via an industrial social media platform. Initially, at 1002, a user subscribes to a maintenance feed on an industrial social media platform for an industrial automation system. In one or more embodiments, the user can subscribe to the maintenance feed using a personal client device (e.g., desktop computer, laptop computer, tablet computer, smart phone, etc.) via a personalized industrial social media page associated with the user. At 1004, social media postings relating to maintenance issues for the industrial automation system are received at the industrial social media platform. These postings can be submitted, for example, by maintenance personnel who are authorized to post updates on the social media page for the automation system. Alternatively or in addition, the postings can be generated automatically by one or more industrial devices comprising the industrial automation system. In such scenarios, the industrial devices can be configured to access the industrial social media system either directly or via a gateway device, and to post information to the maintenance feed in response to a monitored status satisfying a defined condition (e.g., an alarm condition, a process variable or telemetry value exceeding a defined setpoint, a machine downtime status, etc.). At 1006, the received postings are submitted to a maintenance feed viewable by subscribers via their personal social media pages.

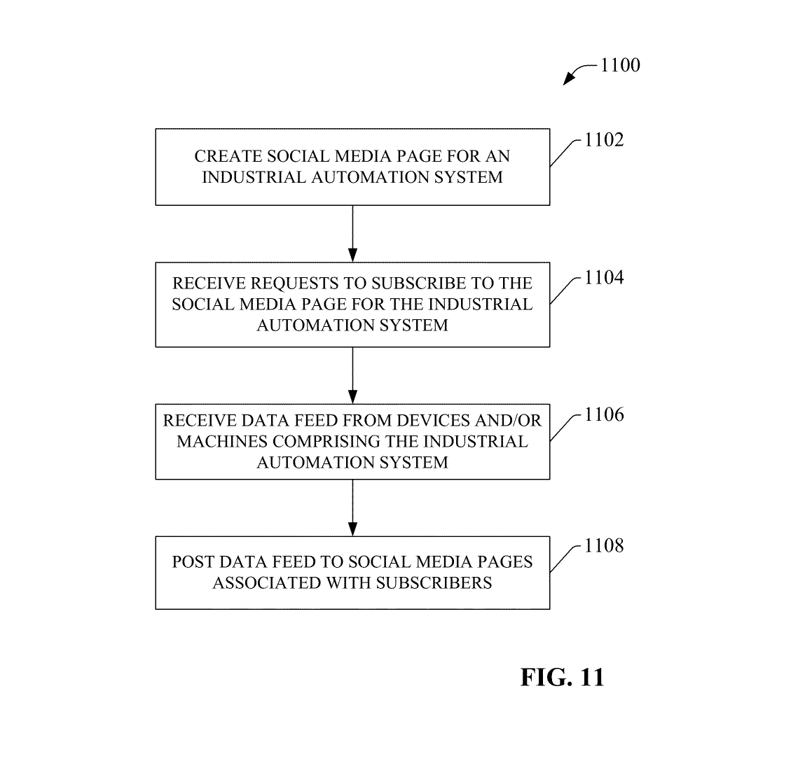

FIG. 11 illustrates an example methodology 1100 for receiving operation updates from an automation system via an industrial social media page. Initially, at 1102, a social media page is created in an industrial social media platform for an industrial automation system. At 1104, requests are received at the industrial social media platform from one or more users to subscribe to the social media page for the industrial automation system. At 1106, a data feed is received at the industrial social media platform from devices or machines comprising the industrial automation system. The data feed can comprise, for example, machine statuses and statistics, process statistics, alarm or fault information, or other such information. In some embodiments, the data generated by the devices can be pushed to the industrial social media platform by one or more gateway devices that collect the data from the devices and move the data to the social media platform. At 1108, the data feed received from the industrial devices is posted to the personal industrial social media pages associated with the respective users who subscribed to the feed at step 1104.

Embodiments, systems, and components described herein, as well as industrial control systems and industrial automation environments in which various aspects set forth in the subject specification can be carried out, can include computer or network components such as servers, clients, programmable logic controllers (PLCs), communications modules, mobile computers, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC as used herein can include functionality that can be shared across multiple components, systems, and/or networks. As an example, one or more PLCs can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC can also communicate to and control various other devices such as I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

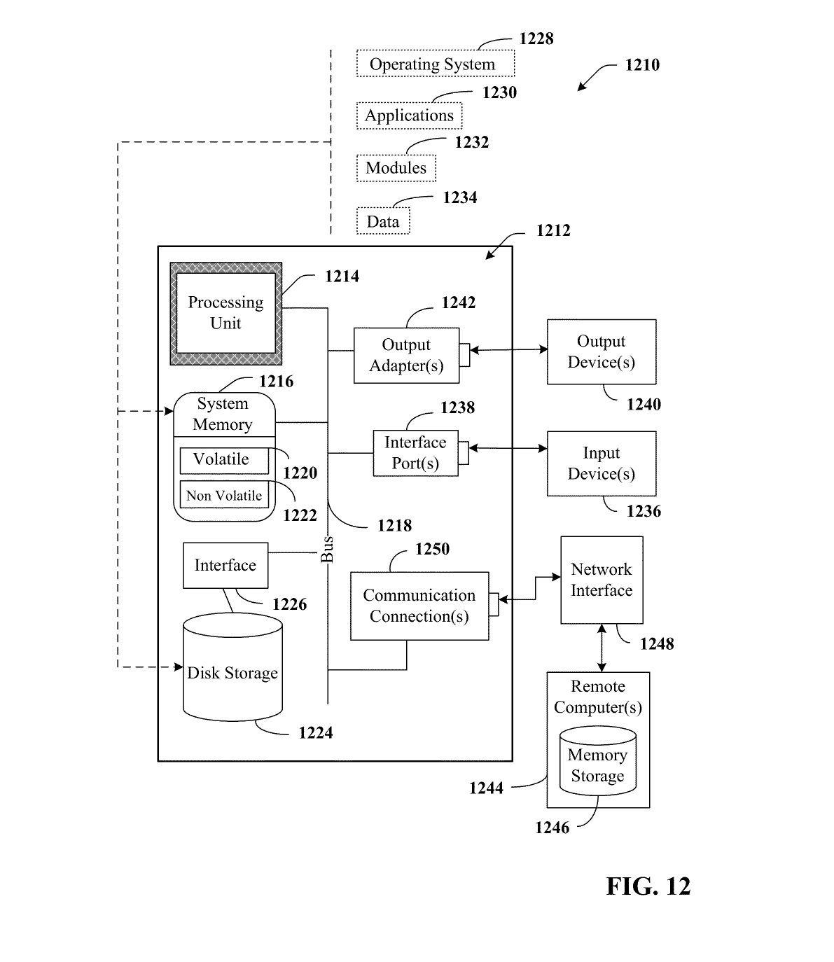

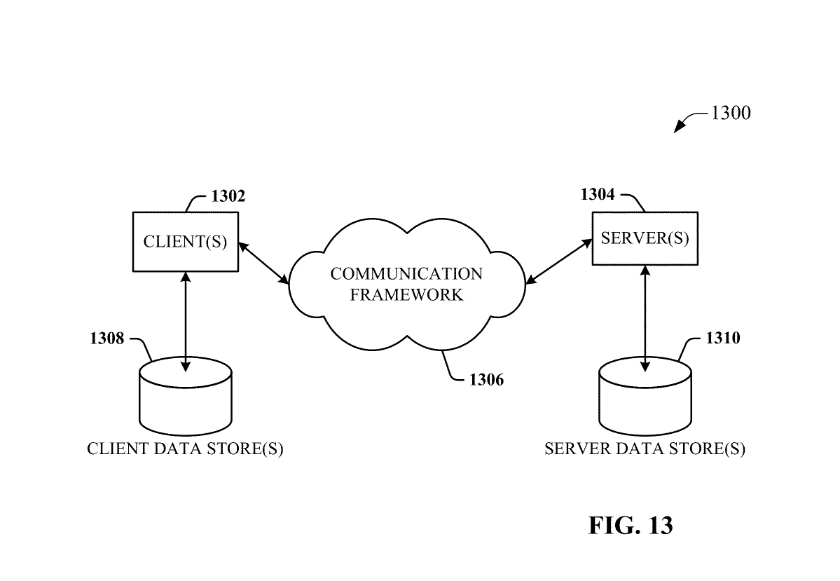

In order to provide a context for the various aspects of the disclosed subject matter, FIGS. 12 and 13 as well as the following discussion are intended to provide a brief, general description of a suitable environment in which the various aspects of the disclosed subject matter may be implemented.

With reference to FIG. 12, an example environment 1210 for implementing various aspects of the aforementioned subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable PROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer 1212. System applications 1230 take advantage of the management of resources by operating system 1228 through program modules 1232 and program data 1234 stored either in system memory 1216 or on disk storage 1224. It is to be appreciated that one or more embodiments of the subject disclosure can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapters 1242 are provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the system bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

FIG. 13 is a schematic block diagram of a sample-computing environment 1300 with which the disclosed subject matter can interact. The sample-computing environment 1300 includes one or more client(s) 1302. The client(s) 1302 can be hardware and/or software (e.g., threads, processes, computing devices). The sample-computing environment 1300 also includes one or more server(s) 1304. The server(s) 1304 can also be hardware and/or software (e.g., threads, processes, computing devices). The servers 1304 can house threads to perform transformations by employing one or more embodiments as described herein, for example. One possible communication between a client 1302 and servers 1304 can be in the form of a data packet adapted to be transmitted between two or more computer processes. The sample-computing environment 1300 includes a communication framework 1306 that can be employed to facilitate communications between the client(s) 1302 and the server(s) 1304. The client(s) 1302 are operably connected to one or more client data store(s) 1308 that can be employed to store information local to the client(s) 1302. Similarly, the server(s) 1304 are operably connected to one or more server data store(s) 1310 that can be employed to store information local to the servers 1304.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system for sharing industrial data, comprising:
a project management component configured to create an industrial social media page for an industrial automation system;
an interface component configured to receive data relating to the industrial automation system; and
a publishing component configured to publish the data to the industrial social media page.

2. The system of claim 1, further comprising a subscription component configured subscribe a user identity to receive updates relating to the industrial automation system via access to the industrial social media page.

3. The system of claim 2, wherein the publishing component is further configured to publish at least a subset of the data to a personal social media page associated with the user identity, wherein the personal social media page comprises a personalized version of the industrial social media page.

4. The system of claim 3, wherein the publishing component is further configured to select at least the subset of the data based on configuration input that selects one or more aspects of the industrial automation system for which the user identity is to receive updates.

5. The system of claim 2, wherein the subscription component is further configured to assign the user identity to a role of a set of defined roles, and wherein the set of roles comprises at least one of an original equipment manufacturer, a plant engineer, a machine operator, maintenance personnel, and a system integrator.

6. The system of claim 3, wherein the publishing component is further configured to select at least the subset of the data based on a role assigned to the user identity.

7. The system of claim 1, wherein the data comprises project data relating to design of the industrial automation system, the project data comprising at least one of a project schedule, a project milestone, a factory acceptance test result, a site acceptance test result, a design specification for the industrial automation system, documentation specifying engineering standards for an industrial facility, identification of one or more preferred vendors, or documentation for the industrial automation system.

8. The system of claim 1, wherein the data comprises maintenance data relating to a maintenance issue for the industrial automation system, the maintenance data comprising at least one of identification of the maintenance issue, a photograph, a graphical trend, a maintenance countermeasure, alarm data, and comments relating to the maintenance issue.

9. The system of claim 1, wherein the data comprises operational data received from one or more devices comprising the industrial automation system, the operational data comprising at least one of a device status, an operational statistic, a production status, a production statistic, fault information, and alarm information.

10. The system of claim 1, wherein the interface component is further configured to serve the industrial social media page to a client device, and to receive the data from the client device via interaction with the industrial social media page.

11. The system of claim 1, wherein the project management component is further configured to maintain a design and installation version of the industrial social media page configured to share first information relating to design and installation of the industrial automation system, and an operation and maintenance version of the industrial social media page configured to share second information relating to operation and maintenance of the industrial automation system.

12. A method for distributing industrial project data, comprising:
creating, by an industrial social media system comprising a processor, an industrial social media site associated with an industrial automation system;
receiving, by the industrial social media system, data relating to the industrial automation system; and
displaying the data on the industrial social media site.

13. The method of claim 12, further comprising subscribing a user identity to the industrial social media site based on subscription request data.

14. The method of claim 13, further comprising
rendering a personalized social media page to a client device associated with the user identity based on the industrial social media site; and
rendering a selected subset of the data on an information feed of the personalized social media page based on a role defined for the user identity.

15. The method of claim 14, wherein the role is at least one of an original equipment manufacturer, a plant engineer, a machine operator, maintenance personnel, and a system integrator.

16. The method of claim 13, further comprising
serving a personalized social media page to a client device associated with the user identity based on the industrial social media site; and
rendering a selected subset of the data on an information feed of the personalized social media page based on configuration data received via the client device that selects one or more aspects of the industrial automation system for which updates are to be received.

17. The method of claim 11, wherein the receiving the data comprises receiving project data relating to design of the industrial automation system, the project data comprising at least one of a project schedule, a project milestone, a factory acceptance test result, a site acceptance test result, a design specification for the industrial automation system, documentation relating to engineering standards in use at an industrial facility, identification of one or more preferred vendors, and documentation for the industrial automation system.

18. The method of claim 11, wherein the receiving the data comprises receiving maintenance data relating to a maintenance issue for the industrial automation system, the maintenance data comprising at least one of an identification of the maintenance issue, a photograph, a graphical trend, a maintenance countermeasure, and alarm data.

19. A computer-readable medium having stored thereon instructions that, in response to execution, cause a system comprising a processor to perform operations, comprising:
creating an industrial social media page for sharing of information relating to an industrial automation system;
receiving, from at least one of a client device or an industrial device, data relating to the industrial automation system; and
displaying the data on the industrial social media page.

20. The computer-readable medium of claim 19, wherein the operations further comprise:
rendering the industrial social media page on a remote client device associated with a user identity; and
rendering a selected subset of the data on the industrial social media page based on a role defined for the user identity
